(19) United States
(12) Patent Application Publication
(10) Pub. No.: US 2015/0043203 A1
(43) Pub. Date: Feb. 12, 2015

(54) LED LUMINOUS TUBE

(71) Applicant: Auralight Internationa AB, Kariskrona (SE)

(72) Inventor: Tomas Bengtsson, Rodeby (SE)

(21) Appl. No.: 14/384,935

(22) PCT Filed: Mar. 15, 2013
(86) PCT No.: PCT/SE2013/050274

§ 371 Date: Sep. 12, 2014

(30) Foreign Application Priority Data
Mar. 15, 2012 (SE) 1250241-5

(51) Int. Cl. F21K 99/00; F21V 7/20

(52) U.S. Cl. CPC F21K 9/175; F21K 9/90; F21V 7/20
USPC 362/218; 29/832

(57) ABSTRACT

The invention relates to a LED lamp (1) shaped as a slim conventional luminous tube, the LED lamp (1) comprising an elongated tubular glass casing (9), a socket (11, 11′) arranged at both ends, a LED unit (3) comprising a plurality of LED circuits (5) arranged on an elongated circuit board (7), and at least one conductor (18, 27, 31), the LED unit (3) being fixated against the first side of a support structure (35), the support structure (35) serving, in the operation of the LED lamp (1), to conduct heat away from the LED circuits (5). The support structure comprises a second side, abutment surface (40) opposite the first side, of the support structure (35), which abuts against the inside (10) of the glass casing (9), the support (35) extending in the longitudinal direction of the LED lamp (1) such that a distance (a) is attained between the support structure (35) and the socket (11, 11′). The invention also relates to a method of preparing the LED lamp by providing the LED unit (3) including the support structure (35) and providing the glass casing (9) at various work stations, and the LED unit (3) is inserted to a predetermined position in the glass casing (9), in which position the support structure (35) extends in the longitudinal direction of the LED lamp (1) such that a distance (a) is attained between the support structure (35) and the socket (11, 11′).

### TECHNICAL FIELD

The present invention relates to a LED lamp according to the introductory portion of claim 1 and a method of manufacturing the LED lamp according to claim 10.

The invention concerns the lamp manufacturing industry, mainly for the manufacturing of luminous tubes or so-called LED luminous tubes.

### BACKGROUND

Traditional luminous tubes of the type gas discharge lamp can be bulky and relatively complex in structure. Traditional luminous tubes may be exposed to harsh environments. These could be industrial premises, process industry with high humidity in the surrounding atmosphere. The luminous tubes may be placed such that they are difficult to access and may require much work effort for changing luminous tubes when the operating time has expired.

The luminous tube industry has for a long time been working on solving the problems related to replacing traditional luminous tubes by alternative luminous tubes, such as T30, which are energy efficient, have long service life, and are waterproof so as to withstand a tough environment for a long time.

In particular, it is desirable to be able to efficiently manufacture LED luminous tubes with small diameter, so-called 16 mm diameter T5 (⅝″).

It is attempted to solve the problems of how to be able to assemble such an alternative luminous tube and how luminous tube body and socket with electric contacts can be arranged in a cost effective way in such a luminous tube.

GB 2,366,610 shows a LED luminous tube which has simple construction and low weight. The LED luminous tube shown in GB 2,366,610 has, above all, been provided in order to replace traditional luminous tubes. In GB 2,366,610 use is made of LED (light emitting diode) circuits, which are arranged in groups aligned on an elongated circuit board with support structure. In operation, the support structure transfers heat from the LED circuits for cooling thereof. A reflector is associated with the support so as to give the light beams produced by the LED circuits multiple lanes and widen the light emission. The support is made of metal or plastic. The LED luminous tube in GB 2,366,610 comprises a glass casing surrounding the LED circuits. The glass is transparent. The LED circuits are alternatively provided with phosphor adjacent the LED circuit per se (near phosphor). An embodiment in GB 2,366,610 also shows that phosphor can be applied to the inside of the glass tube (remote phosphor). Phosphor is used for enhancing the light and has also been used for traditional gas discharge lamps and luminous tubes (a different type of phosphor, however). Furthermore, it is stated in GB 2,366,610 that sockets with electric contacts are used at the ends of the glass tube. The support structure is arranged suspended between the sockets. A reflector is arranged under the LED circuits to reflect light from the LED unit. The reflector includes the support structure supporting the LED circuits and the circuit board. The reflector support structure also helps to conduct heat away from the LED unit and the circuit board in order to prevent overheating of the connections of the semi-conductors.

GB 2,366,610 also discloses that the current can be modulated from a power source so that the LED luminous tube can be mounted in a fixture for conventional luminous tubes. An internal control circuit can control the LED circuits independently of each other.

There are also so-called LED luminous tubes on the market today which are marketed to reduce energy consumption. Often, these are still bulky and are often made of two tube halves enclosing the LED unit, one tube half being made of transparent plastic, and the other half serving as support for the LED circuits and the cooling device. Cooling of the LED circuits is critical, and a LED circuit functions optimally at as low temperature as possible, and preferably lower temperature than about 80 degrees Celsius. They are energy efficient as compared to traditional luminous tubes of the mercury type, but need further development. Because of the larger number of LED circuits width-wise in order to obtain adequate luminous power through the transparent plastic casing, and because of the support of the LED unit at the gables, these known LED luminous tubes thus get too bulky, for example with a diameter of 30 mm.

There are also well-functioning LED luminous tubes on the market including glass tubes surrounding a single row of LED circuits arranged aligned on a support structure. Such a luminous tube which operates satisfactorily is disclosed in U.S. Pat. No. 6,583,550 in the name of Toyoda Gosei Co.

### SUMMARY OF THE INVENTION

Thus, it is an object to solve problems of the prior art in order to obtain a LED lamp which is easy to produce, has small diameter, and which at the same time is reliable in operation so that a long service life can be obtained.

It is also an object to further develop the prior art concerning LED lamps with LED circuits.

One object is to obtain a simple connection of sockets to the glass tube, where at least one socket has at least one conductor extending through the central portion of the socket wall.

It is also an object to obtain a lamp with maximum light output throughout the entire life of the lamp, which lamp has the smallest possible diameter.

Thus, it is also an object to obtain the LED luminous tube with the smallest possible diameter and looking as much as possible like a traditional luminous tube of slim model, for example standard T5.

It is also desirable to be able to cool the LED unit as efficiently as possible in order to thereby prolong the operating time.

It is also an object to widen the angle of light output.

It is desirable to be able to use existing production lines for manufacturing traditional luminous tubes with glass tubes for manufacturing LED lamps shaped as luminous tubes. By using and adapting existing parts of such a production line also for LED luminous tubes, a cost-effective production is obtainable.

### DESCRIPTION OF INVENTION

This has been solved by the LED luminous tube/the LED lamp defined in the preamble, and which is characterized by the characterizing features of claim 1.

In this way a LED luminous tube has been obtained which is operationally reliable, has long life, and which is cost-effective to manufacture. The applicant also calls this type of LED luminous tubes “long life tubular LED lamp”, or, abbreviated, LLTLL.

When the socket is provided with conductor, the end of the support structure (also called integrated cooling flange, reflector, support for LED unit) facing the socket is preferably terminated at a distance of 5-20 mm, preferably 8-15 mm. If the LED lamp is without electric conductor at its second socket (preferably having dummy pin), the other end of the support structure facing the second socket can be terminated adjacent the second socket. If symmetry is desired, there can be the same distance between socket and the end of the support structure on both sides.

In this way, a slim and tight LED lamp shaped as a luminous tube is obtainable, such as 16 mm T5 standard luminous tubes. By arranging the support structure to be tight fitting and fixated (for example by means of silicone glue or other suitable adhesive) to the inside of the glass tube, while at the same time obtaining the support structure with good heat conductivity and light reflecting capacity and also making space for conductor, a non bulky LED lamp is obtainable, such as for example standard T5.

At the same time, moisture and water can be prevented from penetrating into the glass tube body in that preferably there has been provided a larger amount of material of the socket in the area of leading the conductor through the socket. This larger amount of material of the socket wall, in the area of the lead-through, contributes to a tight connection between the conductor and the socket. The sockets are preferably glued onto the respective ends of the glass tube.

Since the sockets do not have to support the LED unit and the support structure, the socket wall can be provided with the lead-through centrally. The LED unit is preferably glued to the inside of the glass tube. A peripheral area with a thinner portion surrounding the thicker portion can thus be arranged between the flange in contact with the glass tube and the thicker portion for the lead-through. This peripheral or intermediate area is thus made thinner in order to obtain resiliency, which prevents cracking, and in this way the LED lamp gets a longer life, both in terms of strength and density. A positive side effect created by making the LED lamp tight is also that dirt particles are prevented from entering the interior space of the LED lamp where the LED units are sitting. Dirt particles otherwise pollute the LED units and the inside of the glass tube, whereby, with time, the light output of the LED lamp is affected. By preventing dirt particles from entering the LED lamp, the life of the lamp is prolonged.

By arranging and fixing the support structure directly against the inside of the glass tube, the socket walls can be free of means for supporting the support structure of the LED unit. Since means for supporting are not required at the socket walls, the socket wall can be made thinner in the area around the thicker portion of the socket member for leading through of conductors, which reduces the tendency of the socket to cracking thanks to a more resilient property of the socket design. By attaching the support structure directly to the inside of the glass tube, the socket wall can also be used exclusively for mounting of conductors or contact pins, which means that the socket wall can be made with small diameter.

The inside of the socket is preferably provided with a semi-circular (a stop means integrated in the socket) flange which with its ends is adjacent to the support structure on the top side in order to prevent twisting of the LED unit relative to the sockets. In this way an extra security has been achieved as regards the functioning of the LED lamp.

The support structure is preferably made of aluminium.

In this way, heat generated by the LED circuits can be conducted away from the circuit board to the glass tube in an efficient manner. Preferably, various heat conducting plastics can also be used for the support structure in contact with the glass of the glass tube. For example, thermoplastics including carbon nanotubes.

Suitably, the abutment surface of the support structure has a radius, seen transversely to the longitudinal direction of the support structure, which corresponds to the radius of the inside of the glass tube.

Preferably, the sockets have dual collars which fit tightly around the wall of the glass casing in the area of the ends.

In this way, the LED lamp can be kept tight so that dirt and pollutants do not enter the LED lamp, which would otherwise cause a shortening of the life of the LED lamp.

Suitably, the second side of the support structure facing away from the LED unit adjoins with its main surface or abutment surface against the inside of the glass casing through contact with the glass casing via a glue joint.

The glue is preferably a silicone based glue. In this way, a secure attachment of the support structure in the LED lamp is obtained, and at the same time the LED lamp can be made with a small diameter. An additional function as to heat distribution is also obtained in that the contact of the support structure with the glass casing entails that atmosphere surrounding the LED lamp can conduct heat away via the glass.

The glue joint suitably extends in an elongated recess arranged in the longitudinal direction of the LED lamp. The glue joint is preferably made in dotted application.

In this way, the manufacturing of the LED lamp can be made cost efficiently.

The sockets are preferably made of plastic.

In this way it has been achieved that a LED lamp can be manufactured cost efficiently. Injection moulding or casting can be used for serial production of the sockets. The strength of the plastic is preferably so great that a torsional moment of 0.5 Nm can be applied to the contact pins. The contact pins are suitably integrated in the sockets such that a tight lead-through of the contact pins/the connectors is achieved.

The support device suitably comprises an integrated cooling device which also acts both as reflector and support for the circuit board relative to the glass casing.

Thus, a compact solution has been obtained, which allows construction of a T5 tube.

Preferably, the LED lamp has a scattering angle of about 180 degrees, and/or the illuminated surface of the glass casing extends at an angle of 194-200 degrees.

Thereby a satisfactory light output is obtained, and through the reflector integrated in the supporting structure, which is glued to the inside of the glass casing/glass tube, the scattering angle can be enhanced, and the glass tube is illuminated over its surface extending over 180 degrees, which gives an aesthetically pleasing appearance.

The outside of the glass casing is preferably coated with polymer plastic. The plastic will then protect the glass if the glass is broken, and sharp edges of possible pieces of glass are covered by the plastic or plastic film. The plastic coating or plastic film suitably acts as diffuser and dims light.

Alternatively, the portion of the glass tube covering the abutment of the support structure against the inside of the glass tube is painted with white paint. Suitably, the white paint is painted separately with white pigment in said polymer plastic which is coated on the glass tube and must harden before applying the next layer of plastic film. Alternatively, the white is painted with separate paint, and then the entire tube circumference is coated with polymeric lacquer.

Alternatively, a foil is applied to the outside of the glass casing in the area of the second side of the support structure.

In this way, the glue joint between the support structure and the glass casing can be hidden to create an aesthetically pleasing design, and at the same time a certain function of conducting heat away is obtainable as the foil is made of heat conducting material. Thereby excess heat can also be conducted away to the sockets, which then also serve as cooling element. Suitably, the foil is heated or glued onto the glass before the sockets are mounted.

This has also been solved by the method defined in the preamble of manufacturing the LED luminous tube/the LED lamp, the method being characterized by the steps set forth in claim 10.

Thus, cost-effective manufacturing can take place, and already existing production lines for traditional luminous tubes can be used.

Preferably the step of preparing the glass casing includes application of phosphor to the inside of the glass tube.

The step of preparing the LED unit suitably includes application of phosphor to the LED circuits.

Preferably, the step of inserting the LED unit is effected uplifted so that the glue applied does not come into contact with the glass casing, where the support structure has a width which is smaller than the inner diameter of the glass casing.

Alternatively, a LED luminous tube drive unit is equipped with an external drive circuit for driving the LED lamp.

Alternatively, a LED luminous tube drive unit is equipped with an internal drive circuit for driving the LED lamp

### SUMMARY OF THE FIGURES

FIG. 1 shows prior art with the features shown in GB 2,366,610, which published patent application the present applicant has taken as basis for his further development of the LED luminous tube.

The invention will now be explained with reference to the drawings, which schematically show:

FIG. 2a one end of a LED luminous tube according to a first embodiment, in section;

FIG. 2b one socket shown in the direction from the glass tube;

FIG. 3 a further embodiment of a LED luminous tube;

FIG. 4 an enlarged portion of the end of a glass tube;

FIG. 5a-5d an example of a method of manufacturing a LED luminous tube;

FIG. 6 a LED luminous tube in cross-section during manufacture as another exemplary method;

FIG. 7 the LED luminous tube of FIG. 6 in cross-section during operation;

FIG. 8 another example of a LED luminous tube;

FIGS. 9a-9b another example of the manufacturing method of the LED luminous tube;

FIGS. 10a-10b a further exemplary method;

FIG. 11 another example of LED luminous tube with glass tube;

FIGS. 12a-12b a further example of LED luminous tubes as embodiment;

FIGS. 13a-13b a further embodiment;

FIGS. 14a-14b a further embodiment for quick-mounting;

FIGS. 15a-15h a method of assembling the components of the LED luminous tube;

FIGS. 16a-16b various variants of drive unit/power supply; and

FIG. 17 the ends of the support structure adjacent a stop means, here in the form of a semi-circular inner flange of the socket.

### DETAILED DESCRIPTION OF EMBODIMENTS AND PREFERRED EMBODIMENTS

The invention will now be explained by means of embodiments. Details in the schematic drawings may occur representing the same type of detail, but in different figures with the same reference numeral. The drawings should not be construed strictly, and details that are not important for the invention have been left out therefrom for the sake of clarity.

First, the prior art shown in FIG. 1 and disclosed in GB 2,366,610 is explained. A tubular LED lamp 101 comprises an elongated glass tube 103, which at each end is provided with a respective socket 105. Contact pins 107 extend through each socket, which pins are in electric communication with a LED unit 109 comprising a number of LED circuits 111 arranged in arrays on an elongated circuit board 113. Since the LED lamp disclosed in GB 2,366,610 is made so as to be tight, contact pins 107 and sockets 105 must be adapted such that they fit tightly relative to each other. This has been solved by the collars 115 of the sockets 105 extending down over the glass tube 103, and the collars 115 each being terminated by a circular slot 117 in which respective ends of the glass tube 103 are arranged. A phosphor coating (reference numeral 7 in GB 2,366,610) is provided on the inside of the glass tube and/or integrated phosphor on the respective LED circuits 111 per se (claim 30 in GB 2,366,610).

The LED unit 109 in GB 2,366,610 is supported against the socket walls 119 of the LED lamp 101 as shown in FIG. 4 in GB 2,366,610. This works satisfactorily when the socket walls 119 in relation to the contact pins 107 are widely apart, which applies to LED luminous tubes with a diameter of 30 mm. This creates space for the centrally positioned contact pins 107, and at the same time space can be attained for the support structure 121 supporting the LED unit 109 at the socket 119.

The LED lamp in GB 2,366,610 also houses an internal electric circuit (not shown) which controls the current to the various LED circuits 111, which can also be individually controlled independently of each other.

The cooling device shown in GB 2,366,610, which serves both as reflector and support for the circuit board, is, as mentioned above, arranged in engagement with the sockets of the LED lamp and is kept in position by these.

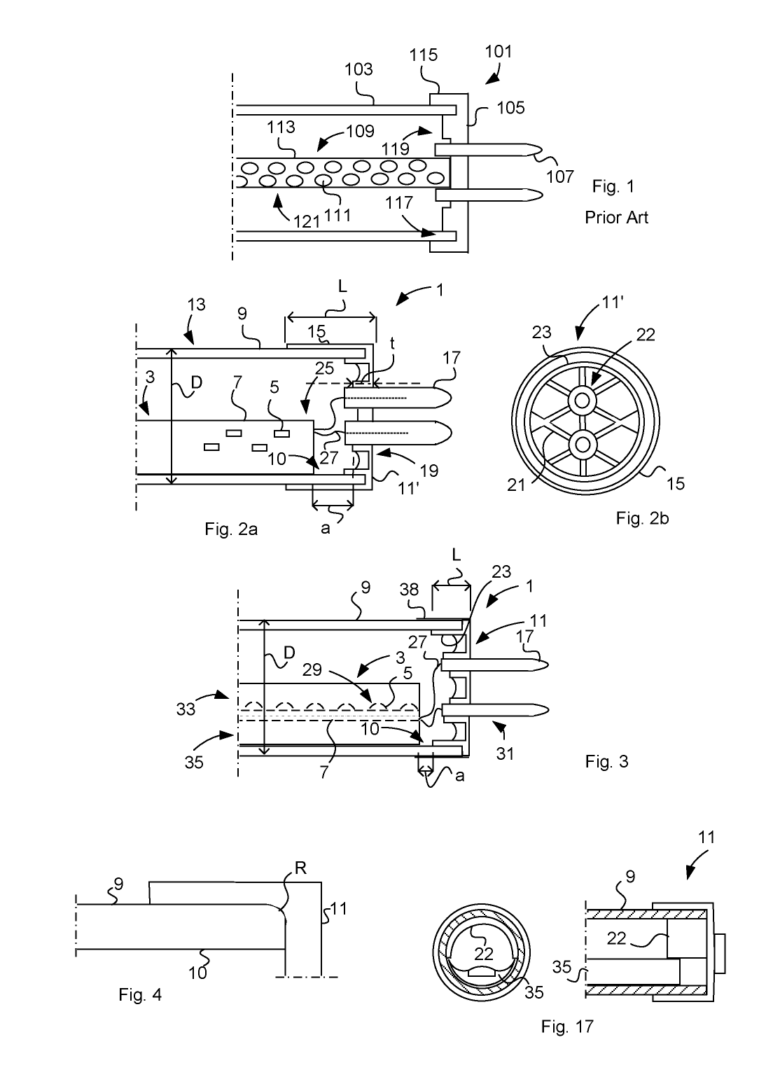

In the following, the various embodiments will now be described as examples of the present invention. FIGS. 2a and 2b show a first embodiment of a LED luminous tube 1. A LED unit 3 comprising LED circuits 5 and circuit board 7 is glued to the inside 10 of a glass tube 9 by means of a silicone based glue (not shown). A socket 11′ is mounted on one end of the glass tube 9 and fits tightly against the outside 13 of the glass tube 9 by means of silicone based glue (not shown). A collar 15 of the socket 11′ sitting on the outside of the glass tube 9 extends a substantial portion over the glass tube 9 (L>D/2) so as to achieve adequate sealing. Contact pin 17 is mounted centrally in the socket 11′. FIG. 2a shows clearly that the socket has a thicker portion with a larger thickness t of the socket wall 19 (extending transversely to the longitudinal direction of the glass tube 9) in the area of the leads-through of the contact pin 17. This larger amount of material of the support wall 19 (the gable) contributes to a tight connection between the respective contact pins 17 and the socket 11′. A peripheral area of thinner (than the thick portion) thickness surrounding the thicker portion is provided between the thicker portion and the start of the collar 15 (ie at the transition between the socket wall 19 and the collar 15). This peripheral area is arranged so as to be thin to obtain resilience of the material, which prevents cracking of the material of the socket 11′, and hence the LED luminous tube 1 gets longer service life, both as regards strength and density. A positive side effect of making the LED luminous tube 1 tight is also that dirt particles are prevented from penetrating into the interior space of the LED luminous tube 1 where the LED unit 3 is sitting. Dirt particles otherwise pollute the LED circuits 5 and the inside 10 of the glass tube 9. All of the above features and mounting characteristics contribute to a tight LED luminous tube of slim T5 model.

Reinforcements in the form of stiffening ribs 21 shown in FIG. 2b are arranged in the socket 11′ between the thicker portions and the transition. In order to further prevent the ingress of dirt, an inner collar 23 of the socket 11′ is arranged at the transition abutting against and glued against the inside of the glass tube. Since the socket 11′ does not need to support the LED unit 3 (the LED unit 3 is fixated to the inside 10 of the glass tube 9, see FIG. 2a), the socket wall 19 can be provided with the lead-through 22 centrally, and the LED luminous tube 1 can therefore be obtained with very small diameter D as compared to the prior art. The LED unit 3 is shorter than the glass tube 9 where a distance a (see FIG. 2a) is attained between the respective end 25 of the LED unit 3 and the respective socket wall 19. This distance a on both sides of the LED unit 3 is sufficient to allow space for conductor 27 and contact pin 17. The LED circuits 5 are arranged in groups. The group (array) is elongated and extends in the extension of the LED luminous tube 1.

FIG. 3 shows a LED luminous tube 1 also with the dimension of a conventional T5 luminous tube. The LED luminous tube 1 includes an elongated tubular, transparent glass tube 9. A socket 11 is arranged at each end of the glass tube 9. A LED unit 3 comprises a plurality of LED circuits 5 arranged in rows on an elongated circuit board 7. The LED circuits 5 are each provided with phosphor 29. Conductors 31 for electric connection to a drive unit (not shown) are connected to the LED unit 3 via cabling 27. The LED unit 3 is equipped with a reflector 33 for reflecting light from the LED circuits 5. The reflector 33 comprises a support 35 made of aluminium fixated to the LED unit 3 for supporting the LED unit 3. The support 35 has a concave recess, which has an elongated semi-open cylinder shape. The recess houses the LED circuits 5. The recess, having a light reflecting curved surface, is made such that the surface reflects light from the LED circuits 5 in the operation of the LED luminous tube 1. The reflector 33 including the support 35 also functions as heat conductor so as to conduct heat away from the LED unit 3 to the glass tube 9 and the sockets 11 in the operation of the LED luminous tube 1. The support 35 including the recess abuts against and is fixated to the inside 10 of the glass tube 9, and the sockets 11 are arranged tightly fitting at the respective ends of the glass tube 9. The conductor 31 is in turn tightly fitting led through one of the sockets 11. The support 35 is glued with heat-conducting silicone glue to the glass tube 9. The distance a on either side of the LED unit 3 is sufficient to allow space for conductor 31 and contact pin 17.

In this way, a slim and tight LED luminous tube shaped as a traditional luminous tube is obtainable, such as a slim 16 mm T5 standard luminous tube. By arranging the support 35 adjacent to the inside 10 of the glass tube 9 and fixated thereto and simultaneously providing the support 35 with a functionality with good heat conductivity and light-reflecting capacity, it is possible to achieve a compact, non-bulky LED luminous tube 1 of standard size T5. The sealing property of the sockets 11 is obtained in this embodiment by the inner collar 23 being arranged with a larger portion inserted in the glass tube 9 with the length L (L>D/3), where the entire exterior side of the glass tube 9 is free so that the LED luminous tube 1 has the same diameter throughout. A sealing film 38 is applied externally around the transition between the glass tube 9 and the socket 11.

FIG. 4 shows how the glass tube 9 after cutting has been provided with a rounding R for easy mounting of sockets 11 and to prevent the glass at the mounting from damaging the material of the socket 11. In this way, cost-effective manufacturing can be obtained simultaneously with the service life of the LED luminous tube 1 being increased as tendencies to cracking are thereby avoided.

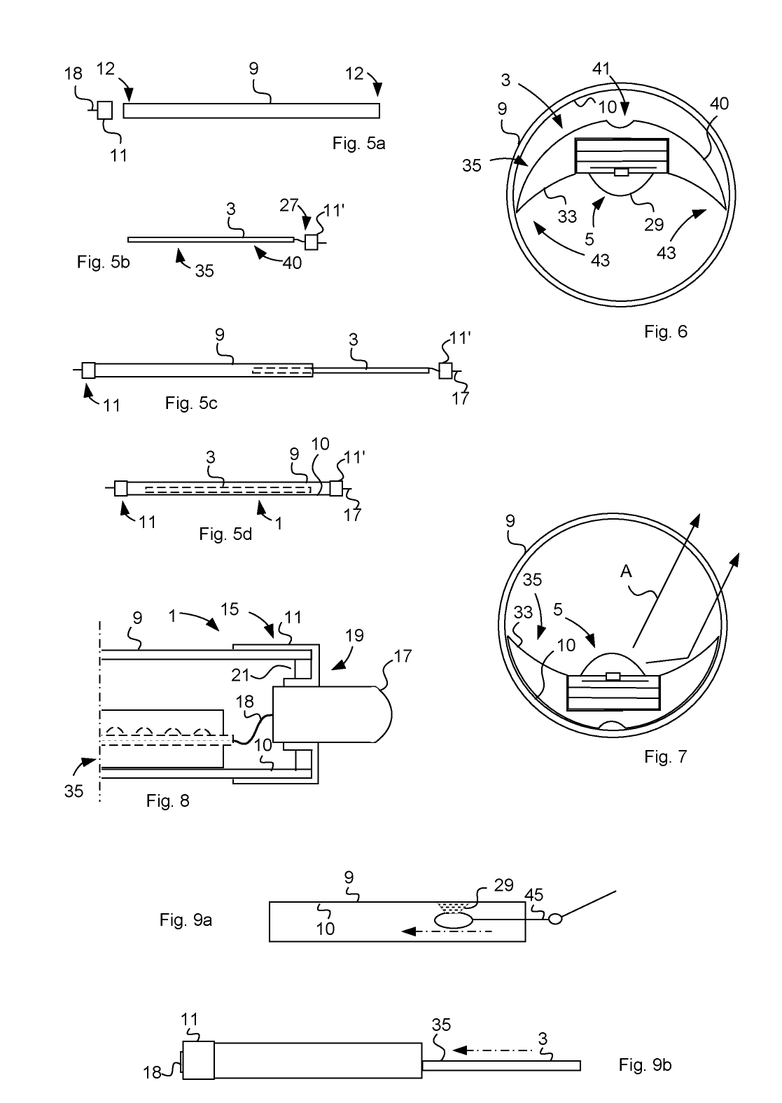

FIGS. 5a-5d illustrate a method of manufacturing the LED luminous tube 1. In FIG. 5a one of the sockets 11 is mounted, here of metal, comprising a pin 18 (not electrically connected to the LED unit, but is there to support the LED luminous tube 1 in a fixture, not shown). This socket 11 is mounted on one end of a glass tube 9 being open at both ends 12. FIG. 5b shows a LED unit 3 including a support member 35 of heat-conducting composite plastic having a lower abutment surface 40 and an upper reflector surface comprising space for LED circuits (not shown). The LED unit 3 is connected to a conductor 27 of a second socket 11′. The abutment surface 40 occupies a main surface of the total outer surface of the support member 35. The abutment surface 40 is provided with silicone glue, and the support member 35 is inserted into the glass tube 9 till the end of the support member 35, which does not include the conductor, receives the previously mounted socket 11. When the support member 35 is inserted into the glass tube 9 it is ensured that the silicone glue does not come into contact with the glass of the glass tube 9, which is shown in FIG. 5c. In FIG. 5d, the support member 35 is lowered till the abutment surface is fully in contact with the inside 10 of the glass tube 9 and the silicone glue comes into contact with the glass. The glue is cured in that the glass tube 9 with mounted LED unit 3 is placed in an oven. The second socket 11′ is mounted, and the LED luminous tube 1 is switched on for testing of function control once before the lamp is packed in suitable packaging.

FIG. 6 shows a further embodiment of a LED luminous tube 1 prepared by is the step described in connection with FIG. 5c. The support member 35 is arranged with its abutment surface 40 facing upwards for application of silicone glue in a straight recess 41 in the abutment surface 40. Reflector 33 and the edges 43 of the support member 35 project further out than the LED circuits 5 with phosphor coating 29, so that a working surface (not shown), against which the edges 43 of the support member 35 abut during the time of the application of said silicone glue, does not come in contact with the phosphor coating 29 of the LED circuits 5. The support portion 35 included in the LED unit 3 is inserted into the glass tube 9, still with the recess 41 facing upwards, and with sufficient distance (clearance) so that the silicone glue (not shown) in the recess 41 does not get into contact with the glass tube 9 during the insertion.

FIG. 7 shows how the glass tube 9 and the support member 35 have been rotated 180 degrees, and the support member 35 has been lowered to the inside 10 of the glass tube 9 for adhesion and curing of silicone glue. FIG. 7 also shows light beams, one of which (reference A) is sent directly through the glass tube 9 from the LED circuit 5, and the second light beam is sent via the reflector 33, where an enhancement of the light is created.

FIG. 8 shows a LED luminous tube 1 with small diameter, such as a T5 tube. A contact pin 17 is mounted on one socket 11. The second socket (not shown) has a corresponding contact pin for electric contact with the LED unit 3. Since the support member 35 is fixated to the inside 10 of the glass tube 9, space can be attained at the socket wall 19 of the socket 11 in the LED luminous tube 1, which space should now only be used for contact pin 17 and cabling 18. According to this embodiment, the socket 11 has also been provided with an external collar 15 or tight-fitting mantle wall positioned on the outside of the glass tube 1. Stiffeners 21 extend in the radial direction and connect a thicker portion of the socket wall 19 at the lead-through of the contact pin 17 centrally positioned in the socket wall 19 (gable) and the transition area to the outer collar 15.

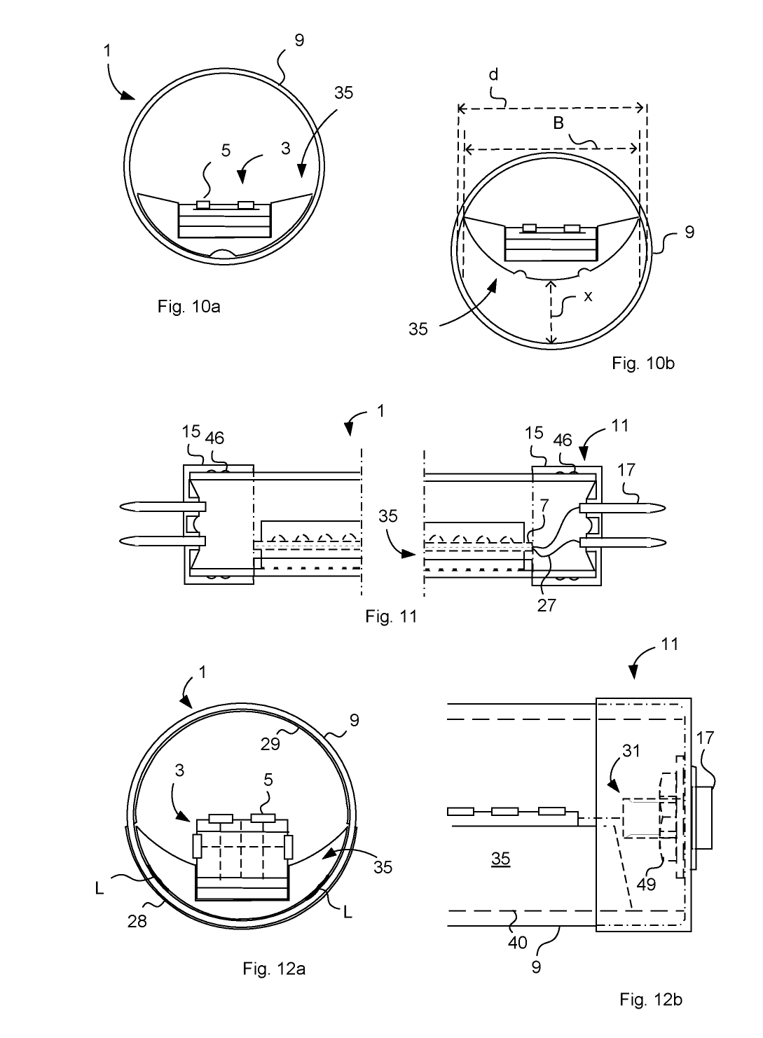

FIG. 9a shows a manufacturing step where, according to a further embodiment, the inside 10 of the glass tube 9 is coated with phosphor 29. The coating is done with a sector of 200 degrees, that is, a sector angle corresponding to the coating of the inside 10 up to both edges 43 of the support member 35. The abutment surface 40 of the support member 35 to be glued in contact with the inside 10 of the glass tube 9 is free from phosphor. Application of phosphor 29 is done by means of an applicator 45 which is moved within, and along, the longitudinal direction of the glass tube 9. When the painting/application is complete, a socket 11 comprising a pin 18 is glued onto one end of the glass tube, which pin 18 is provided as dummy and retaining pin fitting in the fixture (not shown). The LED unit 3 is applied with uncured glue and is then inserted into the glass tube 9 without the support member 35 getting into contact with the phosphor coating 29 on the inside 10 of the glass tube 9.

FIG. 10a shows a LED luminous tube 1 according to a further embodiment. LED circuits 5 are here arranged in dual rows. The LED unit 3 is fixedly pressed into a recess of the support member 35. FIG. 10b shows that the width B of the support member is smaller than the inner diameter d of the glass tube 9, so that the support member 35 can be inserted into the glass tube 9 without getting into contact with its inside 10 and clearance x can be attained at the insertion.

FIG. 11 shows a LED luminous tube 1 with circular cross-section, seen from the side. The LED luminous tube 1 has at each end two pins 17, of which two pins 17 are electrically connected to the circuit board 7 in the area of one of the sockets 11. The pin of the other socket is only for securing the LED luminous tube in a fixture (not shown). Interior grooves 46 in the collars 15 of the sockets 11 are adapted for application of glue, which entails tight attachment of the sockets 11 against the glass tube 9. The support member 35 of the LED unit 3 has such length in the longitudinal direction of the glass tube 9 that the ends of the support member 35 do not extend beyond and below the collars 15. Material of the support member 35 can be saved, simultaneously with the collars 15 making the LED lamp tight.

FIG. 12a shows a cross-section of a LED luminous tube 1 according to a further embodiment. The support member 35 has four rows of LED circuits 5, of which two rows of LED circuits 5 are arranged on the vertical surface of the support member 35. The LED luminous tube 1 has a scattering angle of about 180 degrees and/or the illuminated surface of the glass tube 9 extends covering an angle of 194-200 degrees. FIG. 12b is a side view of the end of the support member 35, which is cut obliquely to increase the abutment surface 40 against the glass tube 9 simultaneously with creating space for conductor 31. According to this embodiment, the conductor 31 is tightly fixated to the socket by means of a nut 49 of electrically non-conducting material screwed onto the conductor 31. A foil 28 (see FIG. 12a) is applied under the LED luminous tube 1 on the outside of the glass tube 9, so that the glue joint between the support structure 35 and the glass tube 9 is not visible. The foil 28 is heat-conducting in order to further conduct heat from the LED unit to the surrounding atmosphere and sockets, the sockets 11 also having contact with the foil 28.

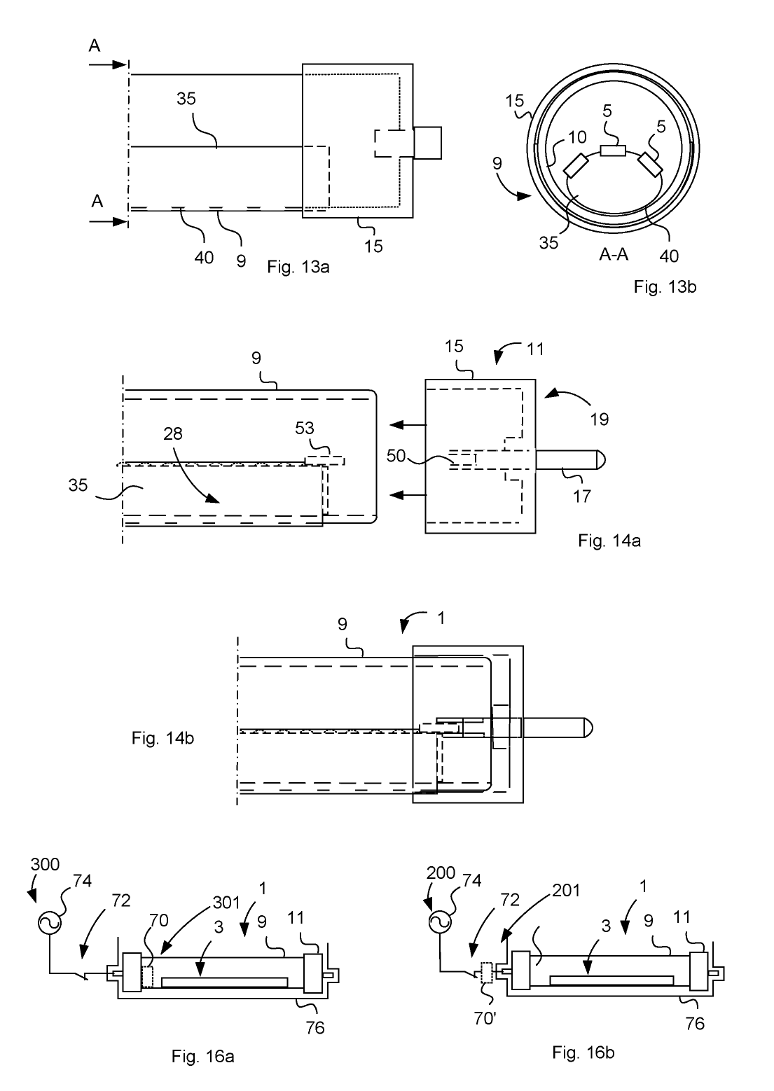

FIGS. 13a and 13b show an embodiment where the support member 35 has an oval cross-section (see the section AA in FIG. 13b, taken in FIG. 13a) to obtain an optimal scattering angle simultaneously with the abutment surface 40 between the support member 35 and the inside 10 of the glass tube 9 being attainable with satisfactory scattering for adequate adhesion.

FIGS. 14a and 14b show another variant of the LED luminous tube 1, where the distance between the socket wall 19 of the socket 11 and the end of the socket member 35 allows the contact pin 17 space so as to be connectable automatically to the LED unit 3 at the mounting of the socket 11 on the glass tube 9. A groove 50 of the contact pin 17 gets into engagement with a contact plate 53 of the LED unit 3 at the mounting of the socket 11 on the glass tube 9.

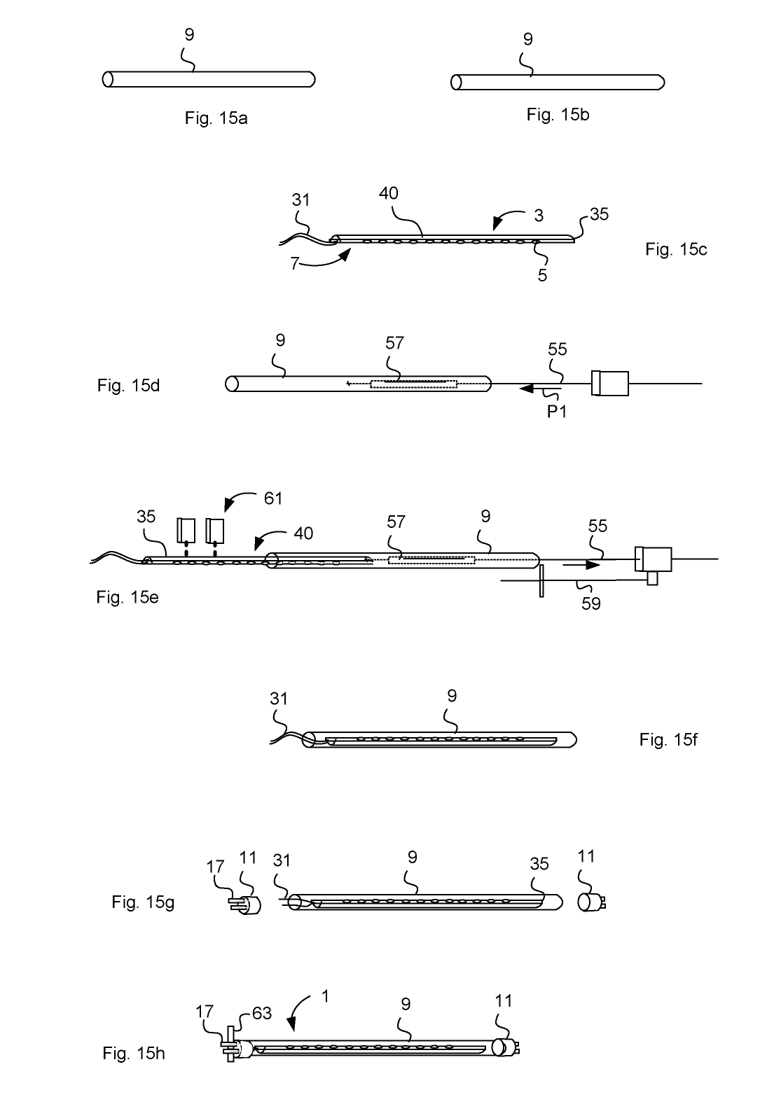

FIG. 15a shows a glass tube 9 made of soda glass. The glass tube 9 is open at both ends. FIG. 15b shows a glass tube 9, which has a portion (area) of its inner surface painted with phosphor. These two variants represent two different embodiments of the LED lamp.

FIG. 15c shows a LED unit 3 including LED circuits 5, support member 35 including a cooling element and reflector integrated with the support member 35, a circuit board 7, and two electric cables 31 for power supply coupled to the LED unit 3. 15d shows how the partially phosphor painted glass tube 9 (with the phosphor free surface facing upwards) is oriented in the correct position. The LED unit 3 is loaded in an adjustable fixture (not shown) with its recess (see FIG. 6) for glue upwards. A rammer 55 comprising a blower device 57 for forming an air cushion between the rammer 55 and the inside 10 of the glass tube 9, thereby avoiding contact between the glass tube and the rammer 55, is inserted into the glass tube according to the arrow P1 to come into engagement with the LED unit 3 positioned on other side of the glass tube 9. FIG. 15e shows how the rammer 55 has engaged with the LED unit 3, and a pusher 59 acts to push the glass tube 9 over the LED unit 3. A glue applicator device 61 provides the abutment surface 40 of the support member 35 with silicone based glue while the LED assembly 3 is being inserted in the glass tube 3. FIG. 15f shows how the glass tube 3 with the LED unit 3 is rotated 180 degrees so that the support member 35 now rests against the inside 10 of the glass tube 9. Curing takes place at about 100 degrees Celsius for 16-20 minutes in an oven (not shown). The rammer 55 and the pusher 59 are released and return again to their load position. FIG. 15g shows how the socket 11 is mounted on the ends of the glass tube 9. First, the cables 31 are cut to a suitable length after the glue between the support member 35 and the glass tube 9 has cured. Each strand (not shown) of the cables 31 is secured in position. Each socket 11 is coated on the inside with heat-resistant silicone based glue for fixed contact with the glass tube 9. The socket 11 for electric contact is applied with the glass tube 9, so that holes (not shown) in the socket pin 17 of the socket 11 receive the incoming strands. A clearance of approximately 0.1 mm is attained between strand and the walls of the hole. Pressing of the contact pin 17 is effected by press jaws 63 shown in FIG. 15h to achieve adequate contact between the contact pin 17 and strands. Then the LED lamp/the LED luminous tube 1 is finished, is switched on for control by means of a drive unit disposed in the production line, and is packaged in suitable packaging by robot (not shown).

The LED lamp can now be used by the consumer. The consumer mounts the LED lamp in a fixture (not shown), and electric current can be supplied to the LED lamp to drive the LED circuits. The electromagnetic spectrum (the light) coming from the LED lamp can be modulated over time by modulating the current (the energy) to one or more of the LED circuits in the same way as is shown in GB 2 366 610. To achieve this, the consumer can use the LED lamp in a fixture which is also coupled to (or includes) a dimmer. Alternatively, the LED luminous tube 1 can be equipped with an internal control circuit (drive unit) in the LED lamp (not shown), which control circuit consists of active and passive electric components which control the current and/or voltage to the LED circuits, either independently of each other or all together. Alternatively, the LED luminous tube can be driven by an external control circuit (drive unit) suitably sitting in the fixture in similar manner as shown in GB 2,366,610.

FIG. 16a shows an example of the LED luminous tube drive unit 300 equipped with an internal drive circuit 301, arranged in the LED lamp, for driving the LED lamp 1. The internal drive circuit 301 comprises a converter/transformer 70. A change-over switch 72 for on and off function of the LED lamp 1 is arranged on a conductor between the power source 74 and the converter/transformer 70′. A fixture 76 holds the LED lamp 1 in place. The drive circuit 301 is of the type shown in GB 2,366,610.

FIG. 16b shows an example of the LED luminous tube drive unit 200 equipped with an external drive circuit 201, arranged in a fixture 76, for driving the LED lamp 1. The external drive circuit 201 includes a converter/transformer 70′. A change over switch 72 for on and off function of the LED lamp 1 is arranged on a conductor between the power source 74 and the converter/transformer 70′.

FIG. 17 shows the ends of a support structure 35 adjacent a stop means, 22 here in the form of a semi-circular inner flange of the socket 11. The waist of the flange extends in the extension of the LED lamp and semi-circularly coaxially with the curvature of the glass tube 9. In this way the support structure 35 is prevented from twisting relative to the sockets 11.

The invention should not be construed to be limited by the above described embodiments, and within the scope of the invention there are also other embodiments which likewise describe the inventive idea. It applies to all embodiments, however, that the abutment surface of the support structure is curved. The curvature is a single curvature and corresponds to the radius which the glass tube has internally in order to obtain adequate contact for good strength and heat conduction. The combination of the embodiments described can indicate the inventive idea. Naturally, instead of glass tubes, other tubes or containers for production of light can be used. These could be quartz glass, Bohemian crystal, tempered glass, metal screen glass, or other mineral melt which has solidified to solid phase without crystallizing, or plastics which are amorphous, similar glasses. The sockets are preferably made of plastic, but may be made of metal or other materials.

The method of manufacturing the LED luminous tube may include other steps for assembling glass tube and LED unit, for example first applying glue to the inside of the glass tube, or to both components simultaneously. Contact conductors between electronics in fixture and LED unit can, in addition to contact pins, consist of contact plates, blocks, permanent soldering, bayonet, screw, etc. The phosphor used can be of inorganic YAG and/or nitride type. It may be yttrium aluminium oxide type (garnet structure) doped with cerium Ce. The nitride type may be a silicon-aluminium oxynitride type. The structure with phosphor (“near” and/or “remote”) is included in a silicone elastomer so that it is heat-stable. It has high purity with well-defined molecular chains with cross-polymerisation. The silicone matrix is therefore an organic silicone material.

1. A LED lamp shaped as a conventional luminous tube, the LED lamp comprising an elongated tubular glass casing, a socket arranged at both ends, a LED unit comprising a plurality of LED circuits arranged on an elongated circuit board, and at least one conductor, the LED unit being fixated against the first side of a support structure, the support structure serving, in the operation of the LED lamp, to conduct heat away from the LED circuits, characterized in that a second side, the abutment side, of the support structure abuts against the inside of the glass casing, the support structure extending in the longitudinal direction of the LED lamp such that a distance is attained between the support structure and the socket.

2-15. (canceled)

16. The LED lamp according to claim 1, wherein the support structure is made of aluminum.

17. The LED lamp according to claim 1, wherein the sockets have dual collars fit tightly around the wall of the glass casing in the area of the ends.

18. The LED lamp according to claim 1, wherein the second side of the support structure facing away from the LED unit with its main surface or abutment surface abuts against the inside of the glass casing through contact with the glass casing via a glue joint.

19. The LED lamp according to claim 18, wherein the glue joint extends in an elongated recess arranged in the longitudinal direction of the LED lamp.

20. The LED lamp according to claim 1, wherein the sockets are made of plastic.

21. The LED lamp according to claim 1, wherein the support structure comprises an integrated cooling device, which also serves both as reflector and support for the circuit board relative to the glass casing.

22. The LED lamp according to claim 1, wherein the LED lamp has a scattering angle of about 180 degrees, and/or the illuminated surface of the glass casing extends covering an angle of 194-200 degrees.

23. The LED lamp according to claim 1, wherein a foil is applied to the outside of the glass casing in the area of the abutment side of the support structure.

24. A method of manufacturing a LED lamp shaped as a conventional luminous tube, the LED lamp comprising an elongated tubular glass casing, a socket arranged at both ends, a LED unit comprising a plurality of LED circuits arranged on an elongated circuit board, and at least one conductor, the LED unit being fixated against the first side of a support structure, the support structure serving, in the operation of the LED lamp, to conduct heat away from the LED circuits, the method comprising:
providing the LED unit including the support structure and providing the glass casing at various work stations;
applying glue within a defined area of a second abutment side of the support structure;
inserting the LED unit to a predetermined position in the glass casing, in which position the support structure extends in the longitudinal direction of the LED lamp such that a distance (a) is attained between the support structure and the socket;
applying the support structure against an elongated portion of the inside of the glass casing;
curing of the glue; and
mounting of the sockets while the conductor is established through fixed contact between a contact element of the socket and the LED unit.

25. The method according to claim 24, wherein the step of providing the glass casing comprises applying phosphor onto the inside of the glass casing.

26. The method according to claim 24, wherein the step of providing the LED unit comprises applying phosphor onto the LED circuits.

27. The method according to claim 24, wherein the insertion of the LED unit is uplifted such that the applied glue does not contact the glass casing and, wherein the support structure has a width, which is smaller than the inner diameter of the glass casing.

28. A LED luminous tube drive unit arranged with an external drive circuit for driving the LED lamp according to claim 1.

29. A LED luminous tube drive unit arranged with an internal drive circuit for driving the LED lamp according to claim 1.
